(19) United States
(12) Patent Application Publication
(10) Pub. No.: US 2017/0316362 A1
(43) Pub. Date: Nov. 2, 2017

(54) SYSTEM AND METHOD FOR VALUE SYSTEM IMPLEMENTATION

(71) Applicant: MASTERCARD INTERNATIONAL INCORPORATED, Purchase, NY (US)

(72) Inventors: Salah Malaika Goss, New York, NY (US); Michael David Angus, Ridgewood, NJ (US); Patrick L. Killian, Cottleville, MO (US); Patricia Reynolds, Trinity, FL (US)

(21) Appl. No.: 15/499,110

(22) Filed: Apr. 27, 2017

Related U.S. Application Data
(60) Provisional application No. 62/328,158, filed on Apr. 27, 2016.

(51) Int. Cl. G06Q 10/06

(52) U.S. Cl. CPC G06Q 10/06313; G06Q 10/067

(57) ABSTRACT

Systems and methods generate a value system scheme defining target entities and recommendations therefore that is usable to develop a value system in a given area. The target entities may include current entities within the area, as well as additional entities needed to successfully implement the value system. The scheme may define a list of use cases, which may be prioritized to further increase viability of the value system when implemented. The scheme may be used to develop a support system based on the recommendations therein. Responsibilities for developing and using the scheme may be distributed amongst different entities to ensure lack of conflicts of interest.

### RELATED APPLICATIONS

This application claims the benefit of priority to U.S. Provisional Patent Application Ser. No. 62/328,158, filed Apr. 27, 2016, which is incorporated herein by reference.

### SUMMARY

Systems and methods generate a value system scheme defining target entities and recommendations that are usable to develop a value system in a given area. The target entities may include current entities within the area, as well as additional entities needed to successfully implement the value system. The scheme may define a list of use cases, which may be prioritized to further increase viability of the value system when implemented. The scheme may be used to develop a support system based on the recommendations therein. Responsibilities for developing and using the scheme may be distributed amongst different entities to ensure lack of conflicts of interest. Resource allocation is differentiated because of the system level approach that the scheme provides. As such, the value system implementation success is significantly increased.

In embodiments, a computer-implemented method for value system implementation includes identifying an area-dependent value system having at least one use case associated therewith. The method may include, for each use case within the value system, generating a status indicator based on performed analysis to identify existing entities within the area. The method may further include, using the status indicator, generating a value system scheme identifying target entities and associated recommendations for each target entity; the target entities including the existing entities and additional entities required to implement the value system.

In embodiments, a system for value system implementation, includes a value system developer including a processor in communication with memory. The memory may store a status analyzer in the form of computer readable instructions that when executed by the processor generate a status indicator for one or more use cases of a value system to be implemented by the system for a given area. The method may further store a value system architect in the form of computer readable instructions that when executed by the processor generate a value system scheme identifying target entities within the area, an implementation plan for implementing the value system, and support recommendations based on the target entities and the implementation plan.

In embodiments, a resource allocation control structure includes a facility implementer including a processor communicatively coupled to memory storing computer readable instructions that when executed by the processor receive input from an allocation unit and generate decisions regarding resource allocation based on the input, the decisions being guided based on a value system scheme generated based on input from an anchor entity the value system scheme including target entities and support recommendations for each of the target entities. The instructions may further be configured to receive input from a control entity regarding oversight of the allocation unit, the control entity being different from the anchor entity.

### BRIEF DESCRIPTION OF THE FIGURES

FIG. 1 depicts a system for value system development and management, in embodiments.

FIG. 2 depicts details of the value system developer, of FIG. 1, in embodiments.

FIG. 3 depicts details of the facility implementer, of FIG. 1, in embodiments.

FIG. 4 depicts an example governing structure for the facility implemented according to facility implementer of FIG. 1, in embodiments.

FIG. 5 depicts a method for value system implementation, in embodiments.

FIG. 6 depicts a method for generating a status indicator used to generate a value system scheme, in embodiments.

### DETAILED DESCRIPTION OF THE EMBODIMENTS

The below embodiments discuss systems and methods that utilize a generated value system scheme defining target entities and recommendations to develop a value system in a given area. The target entities may include current entities within an area, as well as additional entities needed to successfully implement the value system. The scheme may define a list of use cases, which may be prioritized to further increase viability of the value system when implemented. The scheme may be used to develop a support system based on the recommendations within the scheme. Responsibilities for developing and using the scheme, as well as contributable input regarding the scheme and support structure based thereon, may be distributed amongst different components to ensure a lack of conflicts.

Embodiments herein may utilize efforts from governments, private-sector, public-sector, and individuals to provide coordinated and leveraged initiatives to provide resources to developing countries. Utilizing a public-private partnered model, embodiments herein bring to bear domain expertise and, through coordinated planning, increase the impact of each entity's contribution(s) to provide services and resources to developing countries.

Embodiments herein may utilize in-region research conducted by entities with local domain expertise to develop a value system blueprint (herein, “blueprint” can be used interchangeably with “scheme”) of the infrastructure requirements and identify gaps in the target region's resource ecosystem. These requirements may include, but are not limited to: regulatory requirements, remittance requirements, mobile infrastructure requirements, product requirements (such as electronic devices, financial products including checking, credit card, savings, debit card, mobile banking, insurance, etc.), user requirements, cash pool analysis, and customer journey map, and specific use case scenarios required for implementing the blueprint. In embodiments, the blueprint may combine market assessment and region/area-specific value system design to identify the activities, processes, and entities required to implement said activities/processes to reach the desired outcome, along with the recommendations for implementing said outcome. The blueprint may fill in the current picture of the region's available entities, their capacity, business relationships and the regulatory environment based on local research in a participatory process that may include (i) structured interviews, (ii) data collection from local entities such as government, banks, mobile network operators, and financial services companies, which have knowledge of local conditions, and (iii) validation of the findings. The value system design may predict and identify the required elements necessary to execute the resource opportunities identified through the market assessment. This value system design may include (i) a detailed description of each required element in the value system, and (ii) the related business requirements of that element, as well as technical and infrastructure requirements. The value system blueprint may be derived based on a process to organize the inputs into a comprehensive plan, resulting in the identification of a plurality of high-potential scalable use cases. While these use cases will vary by region, some areas, such as agriculture value chains and education payment schema, are expected to be included in most regions.

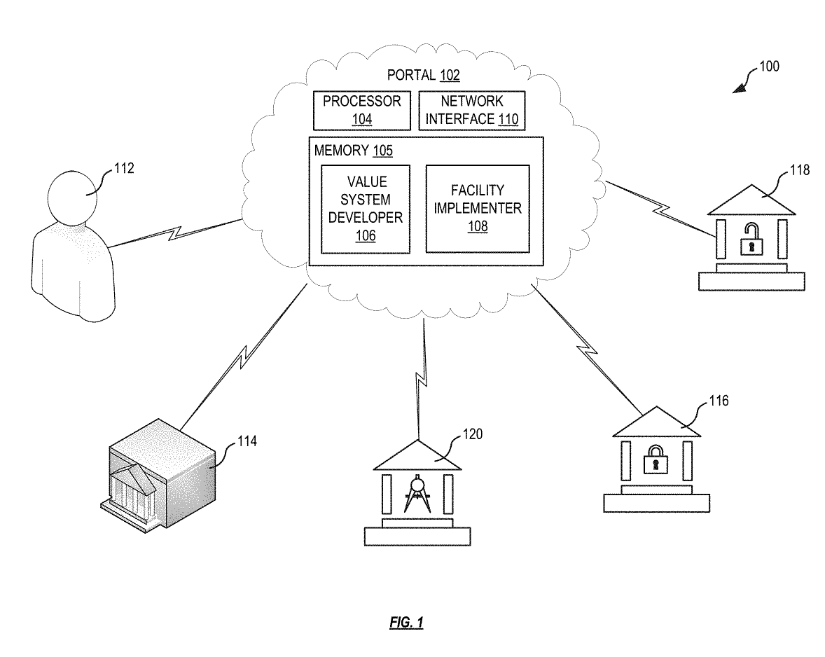

FIG. 1 depicts a system 100 for value system development and management, in embodiments. System 100 may include a portal 102 including a processor 104 and memory 105 storing computer readable instructions that when executed by the processor 104 implement one or both of a value system developer 106 and a facility implementer 108. Processor 104 may be any one or more computing device(s) capable of executing computer readable instructions. Memory 105 may be transitory and/or non-transitory, and is capable of storing computer readable instructions and/or other data as discussed in further detail below. Memory 105 may include one or both of volatile (e.g. RAM, DRAM, SRAM, etc.) or non-volatile (e.g. ROM, PROM, EEPROM, NVRAM, flash memory, solid-state storage, optical or hard disk drives, etc.) memory. Portal 102, processor 104, and/or memory 105 may individually or collectively form a server or bank of servers without departing from the scope hereof.

Portal 102 may be accessible via network interface 110. Network interface 110 may be 1) a wired communication protocol, such as telephone, Ethernet, fiber optics, Cable, USB, lighting cable, or other wired communication protocols; 2) a wireless communication protocol, such as WiFi, cellular 2G, 3G, 4G, 5G, LTE, or other wireless communication protocols; or 3) a combination of wired and wireless communication protocols. Portal 102 may be accessible, via network interface 110, by one or more of a contributor 112, government 114, public entity 118, private entity 116, and anchor private entity (anchor entity) 120. For example, one or more of contributor 112, government 114, private entity 116, public entity 118, and anchor private entity 120, may access portal 102 via an electronic device such as a computer, smart phone, laptop, tablet, kiosk, or other electronic device capable of communicating with portal 102 via network interface 110.

Contributor 112 may provide resources to facility implementer 108. For example contributor 112 may provide debt, grant, and/or equity funding resources. Contributor 112 may be one or both of a public entity and a private entity that contribute to ecosystems developed within system 100. In embodiments, the ecosystem may be a global financial inclusion initiative. One example of contributor 112 includes, but is not limited to, multilateral contributors such as the International Finance Corporation (IFC) or World Bank that offer grant, equity, and debt financial resources to governments, government parastatals as well as private sector companies. Another example of contributor 112 includes bilateral contributors such as United States Agency for International Development (USAID), and Department for International Development (DFID), who on behalf of their governments, design and fund development programs globally. Another example of contributor 112 includes regional banks that typically lend, using concessionary rates to sovereign governments. An additional example of contributor 112 includes private and public foundations that may have philanthropic mandates in expanding access and usage of financial services amongst the unbanked. Another example of contributor 112 includes investors such as the Omidyar Foundation, which invest equity in companies with the expectation of a social impact return. Yet another example of contributor 112 includes Commercial Investors typically investing in fintech in emerging markets, expecting a typical financial return. Any one or more of these examples may be a contributor 112, as well as other types of entities and individuals not listed here.

In embodiments, government 114 may sign commitment letters demonstrating demand for the facility implemented by facility implementer 108 to operate in their respective countries. This is expected to facilitate data collection, the convening of relevant contributors and entities within a given ecosystem and their continued participation in applicable initiatives. These are governments in the countries where resources are being provided, usually in developing countries in Southeast Asia, Africa and Latin America. Many country governments have adopted national financial inclusion strategies or have made similar financial inclusion commitments and are seeking funders and implementing partners. Examples of government 114 include, but are not limited to, any one or more of the following: Ministry of Finance, Central Bank, Ministry of Social Welfare, and other relevant Federal Ministries.

Public entity 118 may contract within portal 102 to carry out agreed upon activities and objectives within the designed ecosystem. In embodiments, public entity 118 may be not-for-profit, governmental institutions or institutions with a social mission. This can include the types of institutions listed as contributors 112 above and can also include Universities or think tanks. Some examples of public entities 118 include, but are not limited to: UN Agencies, Inter-American Development Bank, Global Innovation Fund, etc. In embodiments, public entities 118 are incorporated under a charter (such as the UN charter). The public entities 118 may deal with donor funds or other public funds associated with a greater good or on behalf of the betterment of a population.

Private entities 116 may take part in both the value system developer 106 and the facility implementer 108. Private entities 116 may be incorporated differently from public entities (i.e., not as a non-profit company), and may have a specific expertise and/or experience such as a track record of developing use case and value system design. Private entities 116 may include one or more of global private entities and in-country private entities. For example, global private entities may contribute to the value system developer 106 in accordance to their expertise and related resources. In embodiments, global private entities are defined companies with operations in multiple countries working in financial services, financial inclusion, payments, banking or a related business. Global private entities may likely have interest in or experience with Public Private Partnerships. Global private entities may have expertise in development issues that are complimentary to another entity's expertise (such as the anchor private entity 120) in payments such as supply chain logistics, connectivity, telecommunication infrastructure and requirements, last mile distribution, and/or alternative power sourcing without departing from the scope hereof.

In-country private entities may be amongst the recipients of resource allocation by facility implementer 108. In-country private entities may be defined as companies with business and/or operations in a given market working in financial services, financial inclusion, payments, banking or a related business. In-country private entities may be current or previous recipients of resource allocation to execute financial inclusion or development projects.

In embodiments, the anchor private entity 120 may be a credit card company such as Mastercard (or some qualified financial institution as generally indicated herein). For example, Mastercard Advisors, a selected Mastercard team or the appointed resource may be the architect of the ecosystem design and development work performed using value system developer 106 in each country, calling on Mastercard experts from across the company accordingly. The anchor private entity 120 may be responsible for working with other global private entities 116 (as described above) based on market need. In embodiments, anchor private entity 120 may be a public entity.

System 100 may provide a holistic approach to resource allocation at a regional level. The value system developer 106 may provide interdependent success criteria as discussed below to identify the highest potential use cases for resource allocation scaling, as discussed in further detail below. The facility implementer 108 allocates resource needs identified in the value system in a manner that is inclusive and unbiased. The facility implementer 108 allocates resources using a systematic approach to combine multiple resource origins and increases the availability of resources and access thereto.

The approach used by system 100, and discussed in further detail below, is significantly different from conventional resource allocation approaches. Conventional resource design and allocation programs often lead to confusion, suboptimal results and projects that sometimes work at cross purposes. This creates pain points and exacerbates unmet needs for the various participants because there has never been a “scheme” developed that identifies, defines, and prioritizes various use cases within each value system.

In conventional resource allocation systems, contributors of resources can work at cross purposes and allocation from multiple contributors that lacks coordination from a private company with expertise in resource allocation and identifying a value system/use case which are coordinated. Conventional resource allocation does not occur at a value system level, but instead, focuses on one-off direct resource allocation to individual entities. Moreover, lack of expertise in the resources being allocated results in inadequate resource allocation. Individual resource allocation transaction cost prohibits many and multiple allocations required in each region to adequately support required value systems to scale.

With respect to governments in conventional resource allocation systems, lack of allocation experience (e.g., payment and commerce expertise) results in failed resource allocation. Moreover, governments themselves cannot properly allocate resources to all needed entities. Further, the government themselves cannot properly manage an allocation system. Additionally, market failures warrant targeted intervention to incentivize market entry of required entities and facilitate market coordination. Governments typically cannot provide said targeted intervention.

Public sector institutions also disfavor conventional resource allocation systems (i.e., focus on one-off direct resource allocation to individual entities) because public sector institutions lack resource allocation expertise and/or expert hands-on advisory services to achieve the allocation goals. Further, shortage of resources for all required elements of the value system are not necessarily known to the public sector institutions. Additionally, public sector institutions have difficulty managing the burden of multiple contributors and implementing partner relationships in the allocation system.

Anchor private companies lack ability to fully implement conventional allocation systems. In conventional systems, the anchor private companies have an inability to give resource allocation expertise in a meaningful way within the existing constructs of the system. Incentives to partner with the public sector is not adequately available to anchor private companies. Moreover, the anchor private companies themselves lack ability to fully allocate resources to the needed entities within a given allocation system. Not only have private companies lacked the ability, but in conventional systems, private companies have been barred from working with public companies. As an example, rules within the public company systems (e.g., the United Nations and other development organizations) make it almost impossible to work with the private sector in a manner that brings the private company's expertise to bear on a project basis. So even if private companies had the requisite expertise, they were barred from providing the expertise due to organizational rules. However, the contractual relationships of the system 100 herein, including the organization of the control associated with value system developer 106 and facility implementer 108, reduce potential conflict of interest issues and thereby allow for public and private sector cooperation.

Global private companies also are at a disadvantage in the current systems. Global private companies have an inability to lend their respective expertise in a meaningful way within the existing constructs of resource allocation. There is a lack of or misaligned incentives to partner with the public sector. Further, there are lack of incentives for private and public sectors to cooperate to invest in developing regions. Additionally, there is a high risk factor associated with questionable or unattractive return on investment.

In-region private companies also are at a disadvantage from the given resource allocation systems. There is a lack of or misaligned incentives to partner with the public sector. There is a lack of or inadequate resources for the required system to achieve active customers in the region and facilitate operations of partner companies. Moreover, ill-designed or inappropriate amounts of resource allocation from the public sector lead to unstained product lines or business targets.

In addition, many private and public-sector driven attempts at resource allocation have floundered as a result of not adequately addressing the incentives of both public and private sector actors. Various barriers to entry include service delivery model to governments, classic models of public-private partnerships, traditional development initiatives, and misalignment with private sector business interests.

The traditional service delivery model to governments is product based and usually focuses on the needs of individual ministries of government offices. Many deals with governments underperform as a result of not focusing on building the required value system. Lack of value system focus is a result of: (1) a lack of coordination amongst government ministries, state, and federal governments; (2) constrained government budgets with siloed objectives and disjointed targets; and/or (3) limited resource allocation expertise amongst government officials to inform a focus on development of the value system.

Public-Private Partnerships are focused mainly on corporate social responsibility programs and do not draw on the core business or technical expertise of the private sector partner. As such, classic Public-Private Partnership models do not fully leverage private sector assets because: (1) private sector “partners” are often treated like vendors who are invited to the table at the end of the process; (2) private sector assets are requested to support corporate social responsibility programming rather than decked against core business skills/expertise; and/or (3) the private sector is asked to contribute money or resources on an unsustainable basis and in opposition to their business interests.

Traditional development initiatives are led by international development organization and contributors who design initiatives with a lack of resource allocation expertise. This is because: (1) many international development organizations remain mistrusting of private sector expertise or consultation; (2) development organizations and contributors have rules and procedures that make working with the private sector or other organizations that are for profit onerous if not prohibited; and (3) resources are often misdirected to unsustainable (and often irrelevant) technologies and activities or unavailable for companies critical to the delivery of resources to citizens in a given region.

Furthermore, because most resource allocation designs do not involve the private sector, they are not informed by and often contradict the business interests of the resource recipients they are meant to support. The very companies who are given resources are often not fully set up for success because of objectives and expected outcomes that are not fully aligned to their business interests. This is due to: (1) a lack of understanding of their core business by contributors who have limited industry experience; (2) project targets based on past performance, the growth trajectory of different markets or proxy projections from related business lines and/or products; and/or (3) the necessity to direct resources to one recipient, and in essence “pick a winner” without supporting the business partners and infrastructure that recipient needs to succeed. This weak ecosystem or value chain is often compensated for by increased amounts of resources given to the recipient; this results in artificial levels of activity that end when the resource allocation stake expires.

As will be discussed in detail below, system 100, and the methods associated therewith resolves the above discussed disadvantages of conventional resource allocation processes.

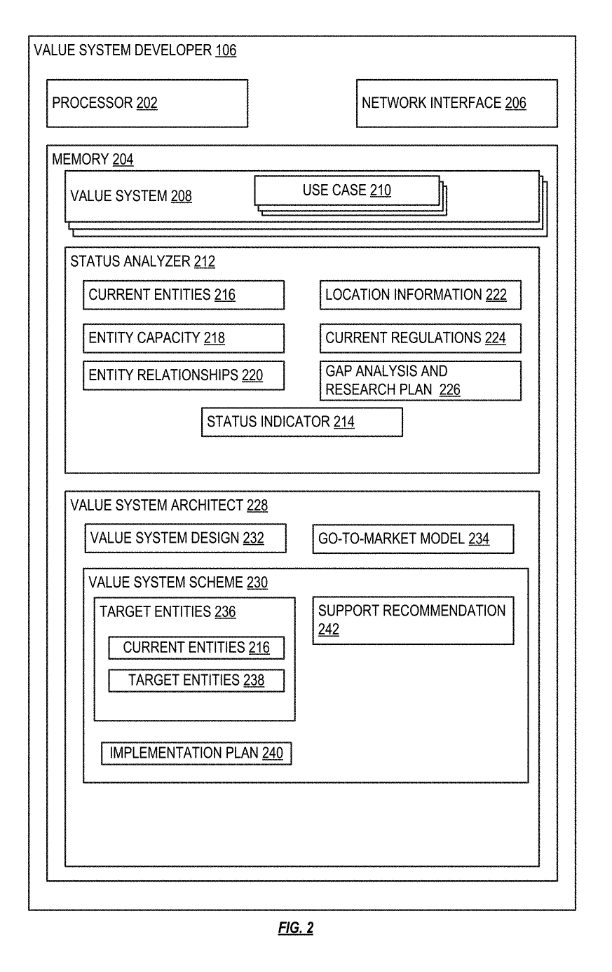

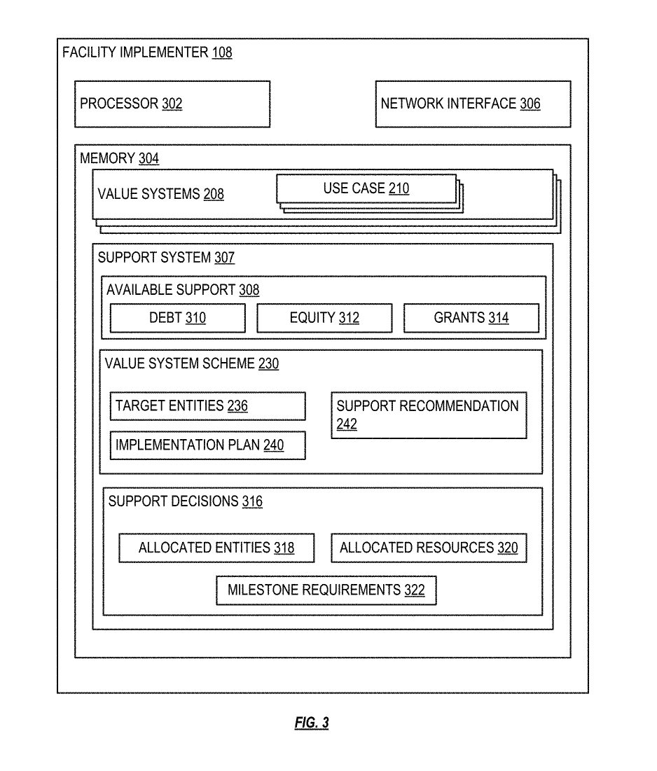

FIG. 2 depicts details of the value system developer 106, of FIG. 1, in embodiments. Value system developer 106 includes a processor 202 in communication with memory 204 and a network interface 206. Processor 202 may be any one or more computing device(s) capable of executing computer readable instructions. Memory 204 may be transitory and/or non-transitory, and is capable of storing computer readable instructions and/or other data as discussed in further detail below. Memory 204 may include one or both of volatile (e.g. RAM, DRAM, SRAM, etc.) or non-volatile (e.g. ROM, PROM, EEPROM, NVRAM, flash memory, solid-state storage, optical or hard disk drives, etc.) memory. Value system developer 106 may form a server or bank of servers and may be part of the server(s) forming portal 102, or separate therefrom, without departing from the scope hereof. In embodiments, processor 202 may be the same device(s), or separate device(s), as processor 104. In embodiments, memory 204 may be the same device(s), or separate device(s), as memory 105. In embodiments, network interface 206 may be the same device(s), or separate device(s), as network interface 306 (shown in FIG. 3).

Network interface 206 may be: a 1) a wired communication protocol, such as telephone, Ethernet, fiber optics, Cable, USB, lighting cable, or other wired communication protocols; 2) a wireless communication protocol, such as WiFi, cellular 2G, 3G, 4G, 5G, LTE, or other wireless communication protocols; or 3) a combination of wired and wireless communication protocols.

Memory 204 may store data regarding one or more value systems 208. Each value system 208 may include one or more use cases 210. A given value system 208 may have interdependencies with other value systems 208. For example, one or more use cases 210 may be utilized within a plurality of value systems 208. Value system(s) 208 may be based on a given region desirous of resource allocation. Region, as used herein, may be a state, country, continent, or any other geographical region (now existing or defined at a later date) without departing from the scope hereof.

The phrase “value system” as used herein may relate to a series of relationships that make up “systems” that are relevant to the daily life of people within a given region. In embodiments, the value system may focus on systems providing resources to underserved and low income consumers, and may be a concentrated geographical commerce system having at least one preeminent use case associated therewith. These value systems may focus on a daily or periodic need that include the resource behaviors of the people, such as the need to pay school fees, send remittances or contribute to savings groups. These value systems may include all necessary infrastructure, participants and technology required to complete the action/transaction upon which the value system is focused. These value systems may include one or more relationships chosen from: payment relationships, data/information relationships, geographic relationships, social relationships, structural/institutional relationships.

One example of a value system is a savings group. Savings groups may be groups of people who come together for the purpose of saving money, then borrowing it at interest to invest in their personal activities (which range from productive investments to paying school fees). These groups provide financial and social safety nets and often used to enforce cultural norms or socialize/teach new information.

Another example of a value system is a school fees and payments system. The payment of school fees and related payments (salaries and school supplies, for example) create a pain point and set of requirements for families, schools and merchants. School fees and payments are a vital part of the customer's financial and social life and, in some communities, accounts for a significant portion of money and time.

Another example of a value system is a social benefits disbursement. In certain communities, social benefits payments are a significant motor of the local economy. The receipt and spend of the social benefit make up a pattern of payments and informational interactions. To a large extent, these social benefits are a missed opportunity to have money that is often born electronic and remain electronic. An overwhelming majority are cashed out upon receipt.

Another example of a value system is Non-Governmental Organizations (NGO) and Innovative Development Organization (IDO) disbursements. NGOs, IDOs and donors who fund and/or administer programs pay a large amount of money to recipients, across a wide range of sectors, as well as administrative program-related costs. The NGOs, IDOs and donors can save on costs as well as potentially reach more recipients by digitizing their payments. For the target beneficiaries, there are often opportunity and other costs related to receiving the payment; a large portion of which is cashed out almost immediately rather than remaining digital.

Another example of a value system is an agricultural commerce hub. The payments and relationships formed around the planting, harvesting and sale of a crop. Small holder farmers and other farming communities are intimately tied to their agricultural value chain for payment and livelihood needs; Savings and Credit Cooperatives (SACCOs) are often implicated in this chain as well.

Another example of a value system is refugee camp commerce hubs. Residency in refugee camps is usual long-term and not transient. Small villages/cities are formed and function within these camps with their own distinctive commerce patterns and infrastructure. This existence shapes the daily lives and related financial behavior of a large portion of the Bottom of the Pyramid.

Another example of a value system is domestic remittances. Domestic remittances or the sending and receiving of money within a region, is thought to occur for 20% of international remittances. Some of these funds are delivered in cash, some by expensive and informal “hawala” services and some are sent electronically, typically using mobile money. Depending on the services available, these transfers can be expensive and time consuming to complete for both the sender and receiver. Domestic remittances are thought to be more voluminous and frequent than international.

Another example of a value system is international remittances. In most developing countries, international remittances are a significant contributor to their Gross Domestic Product (GDP). Many low-income households depend on money sent from family abroad to pay for school fees, medical bills and other household expenses. There are typically few options to send and receive money internationally; most services are expensive and require physical presence to send/receive the transfer.

Another example of a value system is micro-merchants and the fast moving consumer goods value chain. The majority of the purchases made by low-income individuals take place at small shops and kiosks. These kiosks are part of a supply chain that is often structured and includes multiple points of payments and data transfers. The behavior of the kiosk owner is often influenced by the suppliers, wholesalers and other companies in its supply chain.

Another example of a value system is health care payments. Health care expenses are amongst the most high-cost in the budget of low income households. Lack of health insurance usually means a large, unexpected bill to a health care provider who is unable or unwilling to take small installment payments. Transportation costs, doctor bill, hospital bill and medication costs are typical expenses. Lost wages, missed days at school and closure of self-owned businesses are typical costs incurred.

It should be appreciated that these examples of value systems are just examples and that alternate or additional value systems may be implemented using the systems and methods herein without departing from the scope hereof.

The phrase “use case” as used herein may relate to individual resource allocation needs within each value system that express a specific relationship between entities. For example, a use case may define a payer, payee, customer interface and/or service point and related form factor. As another example, within a school payment value system, use cases may include: remote tuition payments, monthly teacher salary payments or payments to vendors for school uniforms and supplies.

Example use cases include, but are not limited to: Value-Added Services (VAS) and bill pay at a merchant within a community commerce hub value system, micro-merchant digital payments in a micro-merchant/everyday commerce acceptance value system; remote micro tuition payments (at a kiosk), salary payments, and uniforms/books/supplies payments in a school fees and payments value system; and mobile money disbursement and cash out of social payments in a social benefits disbursement value system.

The value system may digitize commerce transactions that occur at natural aggregation points in a given community, such as the village market, the neighborhood grocery, or the local mobile airtime seller. A value system may be implemented use cases that provide tangible benefits to the value system while demonstrating the ease of use and simplicity to consumers and merchants. One such use case may be a bill payment at a merchant. This use case may enable merchants and commerce aggregators to pay bills electronically on behalf of community consumers. The use case may occur when a consumer pays merchant cash, or uses off-line card terminal to transfer cash from benefits/salary card; or when a merchant uses digital mobile terminal to pay bill via bill pay app. This use case adds value to the value system because the biller saves money via digital payment, pays commission to merchant as new revenue; and the merchant promotes as free to community consumers to maximize revenue. The use case evolves the value system because consumers experience benefits and ease of use of digital payment that overcomes resistance to direct use. Furthermore, the biller offers discounts to consumers with benefits/payroll card account for direct transaction, paid for by eliminating conversion cost from cash to digital. Each value system 208 and use case 210 may be defined specifically. The value system 208 and related use cases 210 applicable for a given region may be identified (or defined/selected) based on contributor 112 input, desk research, and input from anchor private company 120 to portal 102. Value systems 208 and use cases 210 may be “defined” based on preexisting categories of value systems and use cases, respectively. For example, it may be known that a region with a threshold number of refugees and certain infrastructure may be appropriate for a given value system. Therefore, predefined value systems may be used, and the “definition” of that predefined value system may be altered slightly based on known characteristics (such as population, type of population, infrastructure, etc.) to define the specific value systems 208 and use cases 210 therein.

Information obtained from anchor private company 120 results in quality identification/definition of the use case 210 because of the expertise gleaned from anchor private company 120. Each use case 210 may be defined by a use case template which may include a standard template defining participants, customer segment, current business model, pain points, value proposition and other relevant information and opportunity to improve/scale the use case within a given region. An analysis of the resource allocation opportunity may also be included. The interdependencies to other use cases 210 within a given value system 208 may also be indicated in the use case template.

Value system(s) and use case(s) may include a community commerce hub. Commerce hubs may include places that commerce naturally aggregates. Many value systems and/or use cases may share aspects of a commerce hub. Each community has a number of focal points for economic activity. These points are the nucleus of many different relationships, throughout which payments and data flow. These can include mobile money agents, community latrines, or post offices. These points are not only target adopters of digital payments and financial services but also key influencers. One example of a commerce hub is a neighborhood kiosk. In examples, consumers may shop, sell, get air time, obtain mobile money, pay for school fees, and/or receive their government payments, etc. This infrastructure of the commerce hub may be used by multiple use cases and multiple value systems, so one merchant may be the point of commerce for three or four different use cases.

Memory 204 may additionally store a status analyzer (also called market analyzer) 212. Status analyzer 212 may comprise computer readable instructions that when executed by processor 202 operate to generate a status indicator (also called market report) 214 for selected use cases 210 within a given value system 208. Selection of a use case 210 may be based on an assessment of the technical feasibility, viability, and scalability of the business model and import of interdependencies of entities supporting said use case 210. Selection of use cases 210 may be controlled via interaction of anchor private company 120 with portal 102.

Status indicator 214 may be generated based on market analysis data including one or more of current entities 216, current entity capacity 218, current entity relationships 220, location information 222, current regulations 224, and gap analysis and research plan 226. The status indicator 214 may be region specific and generated for each use case within a given value system. In other words, the status indicator may be tailored for a use case within a specific value system—as opposed to analyzing the market of the entire region and all resources required collectively therein. The result of a status indicator 214 is that the information collected and analyzed indicates precisely what is required to ascertain the technology, processes, and investments, and what entities are currently available, and needed to operationalize each use case. Current entities 216, entity capacity 218, entity relationships 220, location information 222, current regulations 224, gap analysis and research plan 226 may be received by status analyzer 212 via interaction of one or more of government 114, private entity 116, public entity 118, and anchor private entity 120 with portal 102, for example via network interface 110 (or network interface 206).

Current entities 216 data includes information about entities currently within the given region that may be a key player for implementing a given use case 210. Current entity capacity 218 may define the resources already available to each current entity 216, and/or the ability of the current entity 216 to serve citizens of the given region. For example, if a current entity 216 is a bank, the current entity capacity 218 may define products available by the bank (e.g., checking, savings, credit accounts) and the available funding capacities of the bank. Entity relationships 220 may define interdependencies within current entities 216. For example, continuing the bank entity example, entity relationships 220 may indicate companies, such as private entities 116 and public entities 118 that the bank currently partners with. Additionally (or alternatively), entity relationships 220 may indicate support received by government 114 by the bank within the given region. Location information 222 may define regions accessible by each current entity 216.

Current regulations 224 may define regulatory requirements for implementing a given use case 210. For example, government 114 may provide required regulatory environment and potential modification to existing local, state/province, national, and international regulatory regimes including, but not limited to, anti-money laundering (AML), Combating the Financing of Terrorism (CFT), Know Your Customer (KYC), Consumer Protection, Financial Services, Data Privacy, and/or Telecommunications regulations.

Gap analysis and research plan 226 may define holes missing in the data within current entities 216, entity capacity 218, entity relationships 220, location information 222, and current regulations 224 to develop a full use case 210 picture. Therefore, status indicator 214 defines the current status of the region for a given use case, and the gap analysis and research plan 226 defines additional information needed to fully analyze the use case 210. Gap analysis and research plan 226 may include a synthesis of existing data to fill information gaps in use cases 210 which may be developed based on collected desk research. Gap analysis and research plan 226 may define data and research required to complete a value system design and relevant micro and macro information related to an individual use case 210. For example, gap analysis and research plan 226 may include subject matter expert interviews, resource allocation implementation analysis (e.g., comparative payments system analysis) and other information to determine gaps in the current area's entities and infrastructure. The gap analysis research plan 226 may prioritize use cases 210 based on the impact on a given value system 208. The gap analysis research plan 226 may be based on exhaustive desk research conducted to test and validate incomplete or contradictory information collected and to identify the additional data that may need to be collected using primary research. Data collected during market analysis, along with existing data, may be the basis upon which a value system scheme and go-to-market plan is designed; it should address all technical, business model and customer requirements for each use case 210. Gap analysis and research plan 226 may be based on input into portal 102 from a local private company under guidance by anchor private company 120.

Memory 204 may additionally store a value system architect 228. Value system architect 228 may comprise computer readable instructions that when executed by processor 202 operate to generate a value system scheme 230. Value system architect 228 may utilize status indicator 214 and gap analysis and research plan 226, generated by status analyzer 212, to develop a value system design 232. Value system design 232 may be a preliminary value system scheme including reassessment of the technical feasibility, viability and scalability of the business model and import of participants (e.g., entities), interdependencies within a given use case 210, a given value system 208, or a plurality of use cases 210 and value systems 208. This may include validation of the target sector and customer segment. A high-level assessment of existing capabilities (e.g., entity capacity 218) versus additional required capabilities (e.g., as identified in gap analysis and research plan 226 data) as well as an assessment of impact versus complexity of execution may also be validated. The use cases 210 that form the basis of the value system design 232 may be confirmed.

Once value system design 232 is generated, value system architect 228 may generate a go-to-market model 234. Go-to-market model 234 may identify one or more of: additional data and in-country interviews required of use case participants in order to define specific operational requirements and attributes within the value system scheme 230; consultative workshops with use-case participants defining training and to test the use case scenario; and deep-dive sessions with use case participants to gather specific information and/or test the use case. Consultative workshops may include workshops conducted with identified entities potentially receiving support. The focus of the consultative workshops may be on roles of the entity within the use case 210, outcomes available, and timing relative to resource allocation and entity requirements for receiving said resources.

Based on the value system design 232 and the go-to-market model 234 value system architect 228 may generate value system scheme 230. Value system scheme 230 may include a list of target entities 236 required to fulfill each use case 210 within the value system 208. Target entities 236 may include identification one or more of the current entities 216, as well as additional target entities 238 required to implement the use case 210 and/or value system 208. The identification of said target entities 236 may define the required interrelationships between said target entities 236, as well as recommendations of the specific companies, alternative companies, and other operating characteristics for implementing the use case 210 and/or value system 208.

Value system scheme 230 may include an implementation plan 240 which may define interactions with the target entities 236, as well as establish work streams and repeatable business activities required to implement the use cases 210. For example, the implementation plan 240 may identify recommended milestones and entity dependencies to scale the given use case 210. At a value system level, the implementation plan 240 may prioritize the use cases 210 within the value system 208 to identify which use cases 210 must be rolled out first to ensure a successful implementation of the value system.

Value system scheme 230 may additionally include support recommendations 242 for each target entity 236, as well as the steps within the implementation plan 240. Support recommendations 242 may recommend a funding amount, or other resource allocation to each entity within target entities 236 required to ensure successful implementation of the given use case 210 and/or value system 208. The support recommendations 242 may include support recommendations and entity characteristic recommendations including relationship of one target entity 236 to other target entities 236, products that should be produced by each target entity 236, and capacity of each target entity 236 to ensure a successful value system 208.

The resulting value system scheme 230 provides a system level analysis identifying all target entities 236, implementation plan 240, and support recommendations 242 associated with the entities and milestones within the plan to predict a successful rollout of the use cases 210, and the overall value system 208 desired.

FIG. 3 depicts details of the facility implementer 108, of FIG. 1, in embodiments. Facility implementer 108 includes a processor 302 in communication with memory 304 and a network interface 306. Processor 302 may be any one or more computing device(s) capable of executing computer readable instructions. Memory 304 may be transitory and/or non-transitory, and is capable of storing computer readable instructions and/or other data as discussed in further detail below. Memory 204 may include one or both of volatile (e.g., RAM, DRAM, SRAM, etc.) or non-volatile (e.g., ROM, PROM, EEPROM, NVRAM, flash memory, solid-state storage, optical or hard disk drives, etc.) memory. Facility implementer 108 may form a server or bank of servers and may be part of the server(s) forming portal 102, or separate therefrom, without departing from the scope hereof. In embodiments, processor 302 may be the same device(s) as processor 104 and processor 202.

Network interface 306 may be: 1) a wired communication protocol, such as telephone, Ethernet, fiber optics, Cable, USB, lighting cable; or other wired communication protocols; 2) a wireless communication protocol, such as WiFi, cellular 2G, 3G, 4G, 5G, LTE, or other wireless communication protocols; or 3) a combination of wired and wireless communication protocols.

Memory 304 may receive data regarding the value systems 208 and use cases 210 associated therewith as discussed above with respect to FIG. 2. Memory 304 may further store and generate data regarding support system (also called support package) 307. Facility implementer 108 may generate support system 307 based on value system scheme 230, implementation plan 240, and support recommendation 242 associated therewith as transferred to memory 304 from value system architect 228. Support system 307 may allocate available support 308 to one or more of the target entities 236 identified within value system scheme 230. In embodiments, available support 308 includes debt support 310, equity support 312, and grant support 314. The available support 308 may be a blended support including one or more of debt support 310, equity support 312, and grant support 314. A blended support approach differs from typical support allocation because normally there is one entity that offers each of debt, grant, and equity individually. However, the blended support provides those instruments in one entity so, for example, a bank can get a grant and a loan during the same support distribution.

Support system 307 may include support decisions 316. Support decisions 316 may identify the allocated entities 318, the allocated resources 320 to each of the allocated entities 318, and the milestone requirements 322 required for each of the allocated entities 318 to receive the allocated resources 320.

Table 1, below, indicates available support 308 and the potential entities that may be allocated to each type of support, in embodiments. Table 1 is particularly tailored to the embodiment where support includes debt 310, equity 312, and grants 314, but it should be appreciated that alternative types of support and entities may be utilized within system 100 without departing from the scope hereof.

TABLE 1

| | Payments and | | Policy, Regulation, |
|---|---|---|---|
| | Credit | Retail Financial | Capacity Building, |
| | Infrastructure | Services Providers | Research |
| Eligible | Payment | Microfinance | Central |
| Entities | Clearing | Institutions | Banks |
| for | Houses | FinTech | Financial |
| Allocation | Payment | Mobile Network | Regulators |
| | switches | Operators | Civil |
| | Credit rating | Banks | Society |
| | agencies | Insurance | Organizations |
| | National ID | Companies | Research |
| | Schemes | Card Issuers and | Bodies |
| | | Acquirers | |
| Type of | Blended support | Blended support | Grants |
| Resources | including one or | including one or | |
| Available | more of (but not | more of (but not | |
| to the | limited to): | limited to): | |
| Entities | Debt | Debt | |
| Eligible | Equity | Equity | |
| for | Grants | Grants | |
| Financing | | | |

Table 2 depicts example support requirements that may determine the restraints on the available support 308, in embodiments. It should be appreciated that these requirements are examples only, and are not limiting in scope. Different or additional requirements may be utilized without departing from the scope hereof.

TABLE 2

| | | Fund | | |
|---|---|---|---|---|
| | | | | Non-Profit |
| | | Investment Fund | | Fund |
| Window | | Equity | Debt | Grant |
| Eligibility | Investee | Contributors must meet prescribed criteria | | |
| Criteria | | on organizational health, e.g., registered | | |
| | | entity, robust governance structure, credible | | |
| | | management, solvent, financial sustainability, | | |
| | | etc. | | |
| | Type of | Private | Private or | Private or |
| | Entity | | Public | Public |
| | Max Deal | USD $5M | USD $15M | USD $10M |
| | Size | | | |
| | Investment | Up to 7 | Up to 7 | Up to 3 |
| | Duration | Years | Years | Years |
| | Target | 10% | 5-8% | 0% |
| | Return | | | |

Additional or alternative restraints may be implemented. For example, the grants 314 may be governed by standard grant making procedures followed by The Mastercard Foundation, the Gates Foundation or other well established philanthropic organizations. Grant 314 guidelines and allocation criteria may be designed to scrutinize each potential grant award to ensure that it is the best funding tool given the type of institution and proposed activity. Ultimately, the selection of grantee may be driven by their ability to meet specific objectives; however they may also be evaluated according to criteria based on: (i) impact on increase in active customers, establishment of needed infrastructure or product development; (ii) feasibility of achieving the proposed activities including dedicated internal funds; and (iii) sustainability of the initiative and ability to continue post grants.

Debt 310 may be loans structured as commercial loans for private sector or long term concessional loans to governments (similar to World Bank/Official Development Assistance (ODA) terms, e.g., duration and interest rate). Debt 310 may have the ability to be on-lent including to local banks with appropriate rating, other financial institutions and qualifying companies.

Equity 312 may be a closed end fund that is self-sustaining with profits over investor returns, invested back into facility operations. The general investment thesis is a focus on a blend of series A, as well as later stage companies with financial inclusion solutions. The general guidelines for equity 312 allocation may include, but are not limited to, one or more of the following:
Non-control investments or minority stake with appropriate veto rights;
Reserve the right to participate in multiple investment rounds;
Prefer to invest in partnership with other investors (co-investment);
Prefer equity but flexibility to consider alternative instruments (e.g. convertible note); and
Profits made may be cycled back into the investment fund.

Support system 307 may be generated by facility implementer 108 based on input to portal 102 from one or more of contributors 112, government 114, private entities 116, and public entities 118. In embodiments, anchor private company 120 cannot influence facility implementer 108 and generation of support system 307.

For example, to generate support system 307, including support decisions 316, facility implementer 108 may receive input regarding an entity selection process to select allocated entities 318, a technical evaluation of the allocated entities 318, and a funding recommendation to determine the allocated resources 320.

The selection process input may be an open and transparent selection process (for example, from the allocation unit, as discussed below) for funding recipients based on the value system scheme 230. The selection process may be an open or closed request for proposals (RFP) process, individual recipient selection, or some other method used to select the most appropriate recipient of resource allocation. Regardless of the selection method used, the selection process is based on the value system scheme 230 and therefore benefits from the anchor private entity's 120 recommendations and thus achieves the benefit of system level analysis performed in generating the scheme.

The technical evaluation process may be a verification process that the selected entities (selected during the above discussed selection process) meet the criteria identified in the value system scheme 230 support recommendation 242 associated with each target entity 236.

The funding recommendation may identify the allocated resources 320 based on the allocation unit using the value system scheme 230 to determine the official resources allocated to each of the allocated entities 318.

In embodiments, facility implementer 108 may distribute allocated resources 320 after each of the allocated entities 318 give verification that they agree with the approach of the allocated resources 320, the milestone requirements 322, and the implications of their receipt of the resources. Any obligations to expected interactions with a program manager (discussed below) may be explained and agreed to by the allocated entity 318 via interaction with facility implementer 108.

The support system 307 may be modified or updated at any time based on a change or modification within value system scheme 230. For example, additional allocated entities 318 may be identified as milestone requirements 322 when reached, and the region's ecosystem changes.

Generation of support system 307 by facility implementer 108 differs greatly from conventional resource allocation techniques. Rather than focusing on individual resource allocation providers or on specific products, the analysis is focused on the value system scheme defining the use cases and implementation strategy for each use case of the overall value system. The interdependencies and shared infrastructure identified in the value system scheme has never been utilized to generate system level funding recommendations and decisions. Moreover, the resource allocation decisions are implemented based on the milestones identified such that a wave of activities and processes related to resource allocation increase the value system effectiveness. The support system 307 that is generated innovates on “what” will be allocated by taking a system level approach that identifies the entire set of entities that need resources rather than focusing on individual entities without appreciating the relationships between each individual entity. Moreover, the support system 307 bases allocation decisions on operational requirements and the ability of the allocated entity to meet these requirements. Traditional resource allocation is not milestone driven, but instead, is based on theoretical projections, reputation, or past performance. In embodiments allocating resources as debt 310, equity 312, and grants 314, the blended allocation approach combines multiple resources to design tailored allocation based on the needs of each allocated entity. Furthermore, allocation cycles identified by the milestones normally occur by administering a region-specific allocation package that allocates all resources in concert. Coordinating resource allocation based on the milestone requirements 322 ensures that a weak or ill-allocated link in the chain will not cause failure of dependent companies in the value system.

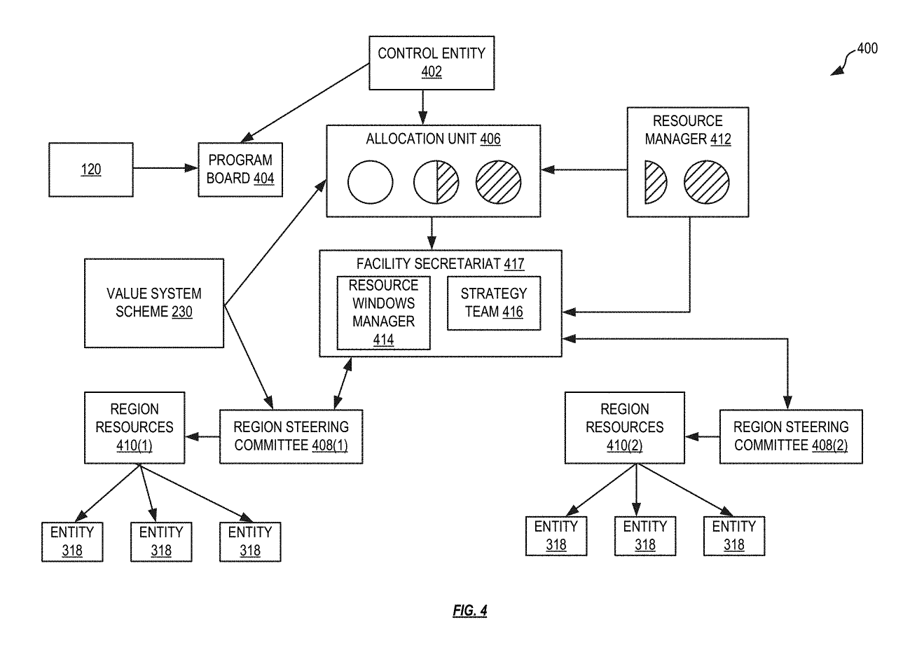

FIG. 4 depicts an example allocation control structure (e.g., governing structure) 400 for the facility implemented according to facility implementer 108, in embodiments. The allocation control structure 400 may define potential input that entities, such as contributor 112, government 114, public entity 118, private entity 116, and anchor private entity 120 can provide to facility implementer 108.

Allocation control structure 400 may be decided based on control by a public entity 118, in embodiments. For example, a public entity 118 (such as the United Nations Capital Development Fund (UNCDF), International Finance Corporation (IFC), other development bank, or other public entity) may manage the facility implemented using facility implementer 108, in embodiments. As such, the public entity 118 managing the facility may appoint a control entity (also called an executive secretary) 402. Control entity 402, and/or public entity 118, may serve as a control entity overseeing the allocation control structure. The control entity 402 may operate to execute resource allocation and agreements between entities and the facility. The control entity 402 may receive input from an advisor, such as the anchor private entity 120. The advisor input may come through a program board 404 which oversees that the facility realizes its mandate, sets strategic direction, reviews performance and approves annual work plans of the facility. The program board 404 may additionally provide feedback on facility performance. The composition of the program board 404 may include one or more of private entities 116, anchor private entity 120, contributors 112, and additional resource allocation experts.

The control entity 402 may oversee an allocation unit (also called an allocation committee) 406, in embodiments. The allocation unit 406 operates to allocate resources based on the value system scheme 230 as discussed above. The composition of the allocation unit 406 may include one or more of private entities 116, contributors 112, and additional resource allocation experts, but in embodiments will not include anchor private entity 120 to ensure unbiased resource allocation.

When the facility is international, a region specific steering committee 408 (specifically 408(1) and 408(2)) may operate to report to the allocation unit 406. The steering committee 408 may be tasked with prioritizing the themes for resource allocation and independently validate the value system scheme 230 generated based on input from the anchor private company 120. The steering committee 408 may report in advance of any allocation entity 318 selection based on knowledge of the region. The steering committee 408 may include one or more of private entities 116, public entities 118, governments 114, and contributors 112, but in embodiments will not include anchor private entity 120 to ensure unbiased resource allocation and additional verification of the value system scheme 230. FIG. 4 is for example shown having a facility that is operational in more than one region. As such, there is a steering committee 408(1), 408(2) associated with each region, each having independent (or the same) regional resources 410(1), 410(2).

The allocation unit 406 may receive input from a resource manager 412. Resource manager 412 may be operational to obtain potential entities based on input received within the value system scheme 230. Because the value system scheme 230 does not specifically define which allocated entities 318 are mandated to receive resources, the resource manager (also called fund manager) 412 may operate to identify specific entities that fit the support recommendation 242 and implementation plan 240 within the value system scheme 230. The resource manager 412 may have one or more resource window managers reporting thereto. The resource window managers 414 may design the resources allocated to each recipient for their respective resource window (e.g., grant, debt, equity). The resource window managers 414 are responsible for financial return expectations and social impact for their specific window, as promised to investors. The resource manager 412 may have one or more members on a strategy team 416. Each of the resource window managers 414 and strategy team 416 may form a facility secretariat 417 which is the main employer for managing resources controlled by the allocation control structure 400. The strategy team 416 team may work directly with allocated entities 318 recipients to ensure their success in filling their designated role in the value system and may function to provide one or more of:
Ecosystem Technical Assistance Officers who provide technical assistance to ensure the achievement of the implementation plan 240. This includes oversight and course correction of the overall ecosystem;
Design as well as technical assistance to individual allocated entities 318;
Monitoring and Evaluation Officers who create and enforce the monitoring and evaluation plan for each allocated entity 318, support system 307 and regional facility deployment.

Allocation control structure 400 may control access to information within portal 102 and each component within the allocation control structure 400 may provide input to the facility implementer 108 according to their various roles. For example, the output of each region's value system schemes 230 may be reviewed and endorsed by a steering committee 408 for that region. Separate and apart from the validation conducted by the steering committee 408, the allocation unit 406 may retain independent analysis to verify the soundness and neutrality of the value system scheme 230 before seeking approval for the determined support system 307. In embodiments, the allocation unit 406 may operate to allocate non-commercial resources, such as grant fund and public debt, whereas commercial resources may be allocated by input from the resource manager 412 to control risk associated with the resource allocation. In embodiments, the control entity 402 may have final approval requirements for all grant and public loan resource allocation, whereas the resource manager 412 is capable of allocating commercial loan and equity resource allocations.

The parties shown in FIG. 1 may serve various roles in the allocation control structure 400 as discussed herein. For example, contributors 112 may sign agreements to contribute resources (e.g., directly into the equity, grant or debt funding windows). Contributor 112 resources may be governed by the rules of the facility implemented by facility implementer 108 into which they have contributed. Confirmed donors may participate in country selection. Contributors 112 may be allowed to add resources to the facilities on a rolling basis or as opportunities (or region work) arise that are of particular interest.

Select public entities 118 with experience running projects similar to the facility may be asked to contract with the anchor private entity 120 to be facility public sector partners. These institutions may sign a partnership agreement that lays out the responsibilities, rights, expected outcomes, and all related activities to be carried out. These institutions may agree to play all or some of the roles important to the facility listed below. Public entities 118 may include a public sector partner institution that plays the majority of these roles and therefore may be named “Anchor Public Sector Partner.” The anchor public sector partner may be in charge of one or more of facility staffing (e.g., contracting and housing facility staff), resource management (e.g., administering contributor 112 resources including contracts and grants management, in embodiments); management of in-region research (e.g., helping the anchor private company and its local research partners to manage local research firms and present/socialize results to in-region stakeholders; market sponsor (e.g., leads relationship engagement with region government 114 and other relevant in-region stakeholders and convenes all relevant parties for facility activities, working sessions and decision-making and soliciting resources from other contributors 112); funding due diligence and risk mitigation (e.g., gathering and analyzing financial, programmatic and business data on perspective allocated entities 318); financial and programmatic reporting (e.g. authoring financial and program reports for contributor 112 and fiduciary compliance); and monitoring and evaluation of the value system scheme 230 (e.g., implementing, monitoring and evaluation plans pre- and post-allocation for each allocated entity 318, and regional portfolio).

Private entities 116 from around the globe may also be selected to participate in the facility. Companies may be chosen whose expertise or core business may contribute relevant data to the value system scheme 230. For example, the anchor private company 120 may establish specific selection criteria. Global private entities 116 may participate in the following tasks to compliment the anchor private company 120 work in each area:
Market Study: Provide primary data and analysis to fill information gaps for relevant use cases 210; contribute to the analysis and impact assessment based on expertise, experience in a given market or access to relevant data.
Value system scheme 230 design: Provide primary data and analysis to compliment the value system scheme 230.
Value system economics: Provide primary data and analysis to ascertain/validate economics of value system 208 participants to inform sustainability plans and go-to-market models.
Implementation plan 240 contributions: Provide primary data and analysis to compliment design of the implementation plan 240.

Certain in-region private entities may be the recipients of resource allocation as well as the focus of the value system scheme 230 and implementation plan 240, particularly if the in-region private entity is one of the current entities 216 identified in the status indicator 214. The types of in-region private entities likely to receive resource allocations include, but are not limited to:
Payments and Credit Infrastructure: Including payment clearing houses, payment switches, processors and credit rating agencies.
Retail Financial Products and Services: Including microfinance institutions, banks, mobile network operators and insurance companies.

Governments 114 may issue requests for the system 100 to operate in their given region. They may act as Program Sponsor and facilitate access to data, information and key local stakeholders.

The allocation control structure 400 may be defined within a partnership agreement and be the legal basis for anchor private company 120 contracts with a public entity 118 to manage certain activities related to the execution of the facility. The partnership agreement may make clear all of the roles, whether filled by the public entity 118 or another entity, required to execute the facility and/or allocation control structure 400; including responsibilities, performance expectation and related activities. It may address all relevant intellectual property issues and ownership of work product. In embodiments, Mastercard is the anchor private entity 120 while the public entity 118 involvement may change based on geography and needed skill set. It is therefore understood that public entity 118 may contract with the anchor private entity 120 to manage certain activities/roles in the execution of the facility but should not own, control or execute the facility programmatically or intellectually. The partnership agreement may codify this understanding.

Value system developer 106 may be controlled by anchor private company 120 based on data input by one or more of government 114, private entity 116, public entity 118, and anchor private company 120. In embodiments, facility implementer 108 may be controlled by a different entity, such as a public entity 118 or based on input from private entities 116, government 114, contributor 112, etc., but without control by anchor private entity 120. This division of control reduces, and in some embodiments, eliminates conflict of interest or unfair advantage because the anchor private company 120 does not control resource allocation to participants of the value system when implemented. Instead, the value system scheme and associated recommendations therewith are just recommendations by the anchor private company 120, whereas actual implementation and resource allocation is controlled based on a different entity such as the public company 118. This control division is radically different from conventional models of resource allocation in which only a single entity, public or private, controls all aspects of design and allocation within a given system.

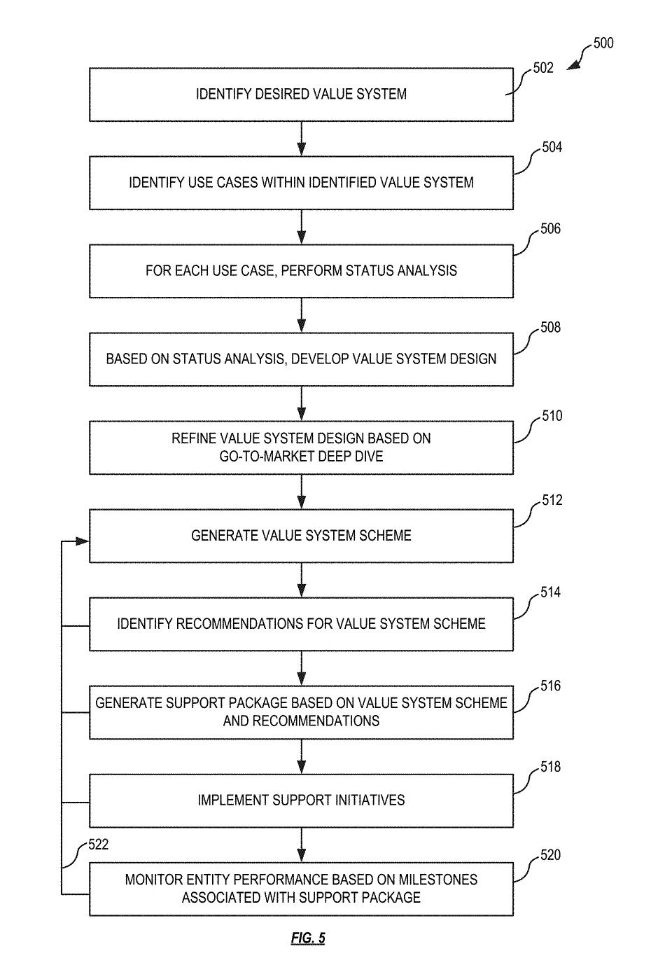

FIG. 5 depicts a method 500 for value system implementation, in embodiments. Method 500 may be performed within and using system 100, as discussed above with respect to FIGS. 1-3. In addition, or alternatively, one or more operations within method 500 may be performed according to allocation control structure 400 discussed above.

In embodiments including operation 502, method 500 identifies at least one desired value system for implementation within a region. In one example of operation 502, one or more value system 208 are defined and/or identified within value system developer 106 of system 100.

In embodiments including operation 504, method 500 identifies at least one use case within each value system identified in operation 502. In one example of operation 504, at least one use case 210 is identified for each value system 208.

In embodiments including operation 506, method 500 performs market analysis for each use case identified in operation 504. In one example of operation 506, status analyzer 212 performs market analysis to identify one or more of current entities 216, entity capacity 218, entity relationships 220, location information 222, current regulations 224 and gap analysis and research plan 226 to develop status indicator 214 as discussed above with respect to FIG. 2.

In embodiments including operation 508, method 500 develops a value system design based on the gap analysis and research plan and/or status indicator identified in operation 506. In one example of operation of step 508, value system architect 228 generates value system design 232 based on one or both of status indicator 214 and gap analysis and research plan 226.

In embodiments including operation 510, if included, method 500 refines the value system design 232 based on a go-to-market model 234 deep dive. In one example of operation 510, value system architect 228 develops go-to-market model 234 to perform a go-to-market deep dive and generate an updated value system design 232 based thereon.

In embodiments including operation 512, method 500 generates a value system scheme. In one example of operation 512, value system architect 228 generates value system scheme 230 as discussed above with respect to FIG. 2. Operation 512 may include prioritizing use cases 210 within the value system 208, identifying the target entities 236 required to implement the value system 208, and identifying the support recommendations 242 associated with the target entities 236.

In embodiments including operation 514, method 500 identifies recommendations associated with the value system scheme. In one example of operation 514, value system architect 228 identifies support recommendation 242 associated with each of target entities 236 and implementation plan 240.

In embodiments including operation 516, method 500 generates a support system based on the value system scheme and identified recommendations from operations 512, 514. In one example of operation 516, value system scheme 230 including support recommendations 242 are transferred to facility implementer 108 which then utilizes said value system scheme 230 including support recommendations 242 to generate support system 307.

In embodiments including operation 518, method 500 implements support initiatives. In one example of operation 518, facility implementer 108 generates support decisions 316 including allocated entities 318, allocated resources 320, and milestone requirements 322, as discussed above.

In embodiments including operation 520, method 500 monitors allocated entity performance based on milestones associated with the support system. In one example of operation 520, facility implementer 108 monitors milestone requirements 322 identified in support decisions 316 to verify that allocated entities 318 are performing appropriately to receive allocated resources 320.

At any time during method 500, the value system scheme generated in operation 512 may be modified as indicated by feedback loop 522.

In embodiments, operations 502-514 are performed based on input by one entity, such as anchor private company 120 and operations 516-520 are performed based on input by another entity without input by the entity providing input for operations 502-514.

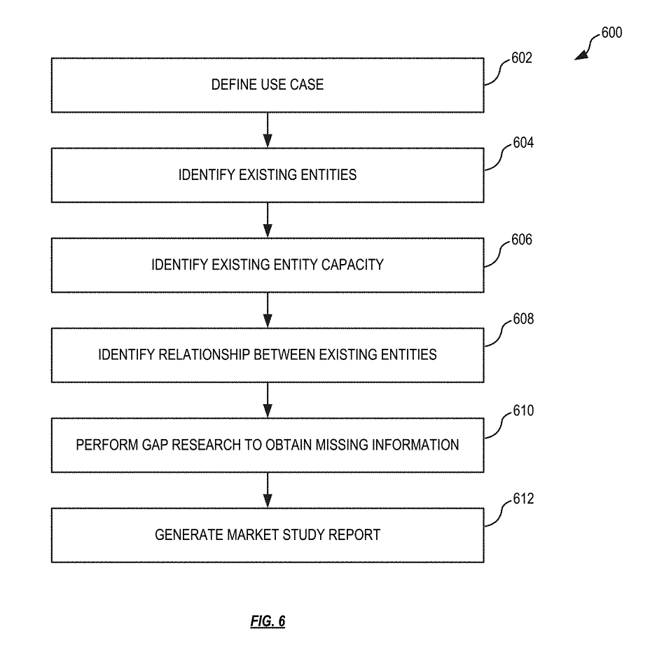

FIG. 6 depicts a method 600 for generating a market study report used to generate a value system scheme, in embodiments. Method 600 is an example of operation 506, and may be performed by value system architect 228 within value system developer 106 of system 100, in embodiments.

In embodiments including operation 602, method 600 defines each use case. In one example of operation 602, value system developer 106 defines each use case 210 including required participants, products, value system, pain points, resource allocation opportunities, size of target population, etc.

In embodiments including operation 604, method 600 identifies the existing entities within the region covered by the value system. In example of operation 604, status analyzer 212 identifies current entities 216 within the region in which value system 208 is to be implemented.

In embodiments including operation 606, method 600 identifies existing entity capacity associated with each entity identified in operation 604. In one example of operation 606, status analyzer 212 identifies entity capacity 218 as discussed above.

In embodiments including operation 608, method 600 identifies relationship between existing entities. In one example of operation 608, status analyzer 212 identifies one or more of entity relationships 220 and location information 222.

In embodiments including operation 610, method 600 performs gap research and identifies a plan to obtain missing information within operations 604-608 required to implement the value system and/or use case. In one example of operation 610 status analyzer 212 performs, or receives, gap analysis and research plan 226 as discussed above.

In embodiments including operation 612, method 600 generates a market study report. In one example of operation 612, status analyzer 212 generates status indicator 214 as discussed above.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A computer-implemented method for value system implementation, comprising:
identifying an area-dependent value system having at least one use case associated therewith;
for each use case within the value system, generating a status indicator based on performed analysis to identify existing entities within the area;
using the status indicator, generating a value system scheme identifying target entities and associated recommendations for each target entity, the target entities including the existing entities and additional entities required to implement the value system.

2. The computer-implemented method of claim 1, further comprising:
assigning a support system to each target entity based on the value system scheme and the associated recommendations.

3. The computer-implemented method of claim 1, the support system including a plurality of milestones required of the target entity; the method further including monitoring the target entity to verify when the milestones are met.

4. The computer-implemented method of claim 3, further comprising modifying the value system scheme based on the monitored milestones.

5. The computer-implemented method of claim 1, the steps of identifying, generating a status indicator, and generating a value system scheme being controlled based on input by an anchor entity.

6. The computer-implemented method of claim 5, further comprising assigning a support system to each target entity based on the value system scheme and the associated recommendations, the step of assigning a support system being controlled based on input by a control entity.

7. The computer-implemented method of claim 1, the step of generating a value system scheme including: prioritizing use cases within the value system, identifying the target entities required to implement the value system, and identifying the associated recommendations for the target entities.

8. The computer-implemented method of claim 7, the recommendations including support recommendations and entity characteristic recommendations.

9. The computer-implemented method of claim 8, the entity characteristic recommendations including relationship to other target entities, products produced by each target entity, and capacity of each target entity.

10. A system for value system implementation, comprising:
a value system developer including a processor in communication with memory storing:
a status analyzer in the form of computer readable instructions that, when executed by the processor, generate a status indicator for one or more use cases of a value system to be implemented by the system for a given area;
a value system architect in the form of computer readable instructions that, when executed by the processor, generate a value system scheme identifying target entities within the area, an implementation plan for implementing the value system, and
support recommendations based on the target entities and the implementation plan.

11. The system of claim 10, the status indicator defining current entities within the area, respective capacity of the current entities, respective relationships between the current entities, and location information of the current entities.

12. The system of claim 11, the status indicator further defining current regulations within the area.

13. The system of claim 11, the status indicator including gap analysis and research plan information required for creating a value system design.

14. The system of claim 10, the value system architect including computer readable instructions for creating (1) the value system scheme based on a value system design based on the status indicator, and (2) a go-to-market model generated by the value system architect identifying additional information required of the target entities.

15. The system of claim 10, the implementation plan including a prioritized list of use cases for implementing the value system.

16. The system of claim 10, the value system developer in communication with a facility implementer comprising computer readable instructions stored in memory that, when executed by processor, generate a support structure including decisions on allocated resources for one or more allocated entities that implement the value system, the support system based on the value system scheme and recommendations therein.

17. A resource allocation control structure, comprising:
a facility implementer including a processor communicatively coupled to memory, the memory storing computer readable instructions that,
when executed by the processor:
receive input from an allocation unit and generate decisions regarding resource allocation based on the input, the decisions being guided based on a value system scheme generated based on input from an anchor entity, the value system scheme including target entities and support recommendations for each of the target entities;
receive input from a control entity regarding control of the allocation unit, the control entity being different from the anchor entity.

18. The resource allocation control structure of claim 17, the instructions further configured to receive input from a resource manager reporting to the allocation unit; the input from the allocation unit being associated with non-commercial resource allocation and the input from the resource manager being associated with commercial resource allocation.

19. The resource allocation control structure of claim 17, the input from the allocation unit including information from a plurality of areas, each area including an area committee responsible for identifying specific target entities within a given area for implementing the value system.

20. The resource allocation control structure of claim 17, the facility implementer being a portion of a portal accessible by each party within the allocation control structure including a network interface for receiving the input.
